(19) United States
(12) Patent Application Publication
(10) Pub. No.: US 2009/0308355 A1
(43) Pub. Date: Dec. 17, 2009

(54) Fuel injection control method and fuel injection control apparatus

(75) Inventor: Yukio Ichikatai, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi (JP)

(21) Appl. No.: 12/213,138

(22) Filed: Jun. 16, 2008

(30) Foreign Application Priority Data
Aug. 21, 2007 (JP) 2007-214234

(51) Int. Cl. F02M 51/00

(52) U.S. Cl. 123/479

(57) ABSTRACT

An electronic control unit corresponding to a fuel injection control apparatus measures an interval time in ignition signals input by wirings, detects an erroneous connection of wiring by comparing a combination of the measured interval times with a combination of interval times in the case that the wiring is in a correct connection in the same engine stroke, which is previously stored, corrects a setting in such a manner as to output the fuel injection signal to the same cylinder at the same timing as the case that the wiring is in the correct connection, by detecting the erroneous connection and stores the setting, and thereafter outputs a fuel ignition signal on the basis of the corrected setting.

### BACKGROUND OF THE INVENTION

1. Field of the Invention

The present invention relates to a fuel injection control method and a fuel injection control apparatus, and more particularly to a fuel injection control method of carrying out a fuel injection at a correct injection timing per cylinder even in the case that a wiring transmitting an ignition signal from an ignition device for a predetermined cylinder is erroneously connected to a fuel injection control apparatus utilizing an ignition signal generated by the ignition device as a reference timing of a fuel injection timing in an engine having a plurality of cylinders, and a fuel injection control apparatus for executing the method.

2. Description of Related Art

In a fuel injection system feeding a fuel to an engine having a comparatively compact and simple structure such as a general purpose engine or the like, a data for comprehending an operating state of the engine such as a crank angle position, an engine speed or the like is generally used for a control by detecting an ignition signal of a magnet type ignition device by means of a fuel injection control apparatus without using any dedicated crank angle sensor.

For example, in a fuel injection control per cylinder in the engine, as described in Japanese Unexamined Patent Publication No. 6-10746, there has been known a system structured such that a fuel injection control apparatus detects a temporary side voltage signal of the ignition device and generates a valve opening signal by setting this to a reference timing so as to output the signal to each of the injectors per cylinder, thereby executing a fuel injection control.

In the fuel injection system of the engine mentioned above, in the case of an engine having a plurality of cylinders in which ignition timings are different per different cylinders, as shown in a layout view of FIG. 5, ignition devices 2 and 3 are necessary per cylinders 42 and 43 having different injection timings, and are connected to an electronic control unit 11 executing a fuel injection control respectively by wirings 21 and 31. In this case, for example, there is generated a case of an erroneous connection such that the wiring 21 from the ignition device 2 for the cylinder 42 corresponding to a first cylinder, and the wiring 31 from the ignition device 3 for the cylinder 43 corresponding to a second cylinder are connected to an input terminal in the electronic control unit 11 side.

In this case, the electronic control unit 11 injects the second cylinder at an ignition timing of the first cylinder, and injects the first cylinder at an ignition timing of the second cylinder, whereby there is generated such a trouble that a malfunction of an engine operation is caused and a defect of an emission is generated. However, in the fuel injection system such as the general purpose engine or the like in which an inexpensiveness is demanded while being a simple structure, since it is normal that a cylinder discriminating means by a crank angle sensor or the like is not arranged, and there is not provided with a function of detecting the erroneous connection mentioned above and correcting the timing of the fuel injection signal, it is impossible to avoid an engine malfunction and it is hard to specify a cause thereof, so that there is generated a status that the connection is hard to be corrected.

### SUMMARY OF THE INVENTION

The present invention is made for the purpose of solving the problem mentioned above, and an object of present invention is to execute an equivalent fuel injection control to the case of a correct connection without correcting a connection, by detecting an erroneous connection of wiring between an ignition device and a fuel injection control apparatus without accompanying a increase of a cost, in a fuel injection control apparatus of an engine having a plurality of cylinders and utilizing an ignition signal of an ignition device as a reference timing of a fuel injection timing.

In order to solve the problem, in accordance with the present invention, there is provided a fuel injection control method executed by a fuel injection control apparatus which is provided in the engine having a plurality of cylinders in which ignition timings are different from each other per cylinder, and outputs a fuel ignition signal to an injector provided in each of the cylinders while using an ignition signal received from a plurality of ignition devices via wirings as a reference timing of the fuel injection timing, comprising the steps of:

detecting an erroneous connection of the wiring by comparing a combination of an interval time in ignition signals input by a plurality of wirings which are continuously measured, with a combination of the interval time in the case that the wiring is in a correct connection in the same engine stroke, which is previously stored, in accordance with a predetermined comparing method;

correcting a setting in such a manner as to output the fuel injection signal to the same cylinder at the same timing as the case that the wiring is in the correct connection, and storing the setting; and

thereafter outputting a fuel ignition signal on the basis of the corrected setting.

As mentioned above, it is possible to inexpensively and simply detect the erroneous connection of the wiring to which the ignition signal is input, by measuring the interval times of the ignition signal and comparing the combination of the interval times with the combination of the interval times in the case of the correct connection, while utilizing the fact that the intervals of the continuously input ignition signals are different from each other, whereby it is possible to output the fuel injection signal to the same cylinder at the same timing as the case of the correct connection.

Further, in the fuel injection control method, in the case of detecting the erroneous connection of the wiring, it is possible to correct to the correct injection timing in accordance with the simple processing procedure using the input ignition signal, by changing the input terminal information for specifying the cylinder being relevant to the ignition signal which is previously stored per a plurality of input terminals of the fuel injection control apparatus to the input terminal information specifying the actually relevant cylinder and correcting the setting.

Further, in the fuel injection control method mentioned above, if the method of comparing the combinations of the interval times is structured such as to detect the erroneous connection by measuring a first interval time from an input of an ignition signal for a predetermined cylinder to an input of the next ignition signal, measuring a second interval time from the input of the next ignition signal to an input of further the next ignition signal, and comparing a relation between the first interval time and the second interval time with a correct relation between the first interval time and the second interval time in the case that the wiring is in the correct connection, which is previously stored, in accordance with a predetermined procedure, it is possible to automatically detect the erroneous connection of the wiring to the ignition device without any cylinder discriminating means such as the crank angle sensor or the like.

Further, if the comparing procedure in this case is structured such as to compare a magnitude relation between the first interval time and the second interval time or a numerical value indicating a ratio between the first interval time and the second interval time, and determine the erroneous connection in the case that both do not coincide, it is possible to securely detect the erroneous connection in accordance with a simple procedure without imposing an excessive process burden on the fuel injection control apparatus.

Further, in accordance with the present invention, there is provided a fuel injection control apparatus of an engine having a plurality of cylinders comprising:

a plurality of input terminals for inputting an ignition signal by connecting each of wirings extended from ignition devices arranged in a plurality of cylinders;

an interval measuring means measuring an interval of the input ignition signals;

an interval time storing means storing a combination of the interval times in the case that the wiring is in a correct connection in the same engine stroke;

an erroneous connection detecting means detecting an erroneous connection of the wiring by comparing a combination of stored interval times with a combination of the measured interval times;

a setting changing means changing a setting in the case of detecting the erroneous connection; and

a setting storing means storing the setting after being changed,

wherein the fuel injection control apparatus executes the fuel injection control method mentioned above. In accordance with this fuel injection control apparatus, it is possible to easily execute the fuel injection control method mentioned above only by arranging the fuel injection control apparatus in a fuel injection system of the engine.

In accordance with the present invention structured such as to measure the interval times of the input ignition signals, detect the erroneous connection of the wirings to which the ignition signals are input, by comparing the combination with the combination of the interval times in the case that the connection of wiring is in the correct connection, and change the setting in such a manner as to output the same fuel injection signal as the case of the correct connection, it is possible to detect the erroneous connection of the wiring without accompanying an increase of a cost, and it is possible to execute the identical fuel injection control to the case of the correct connection, without actually correcting the connection.

### BRIEF DESCRIPTION OF THE DRAWINGS

FIG. 1 is a layout view of a fuel injection system of an engine in accordance with an embodiment of the present invention;

FIG. 2 is a flow chart showing a procedure of a fuel injection control method by an electronic control unit in FIG. 1;

FIG. 3 is a graph showing in a time series manner each of ignition signals detected by an electronic control unit in FIG. 1 in the case that an erroneous connection does not exist in a wiring, and an ignition signal output in correspondence to the ignition signals;

FIG. 4 is a graph showing in a time series manner each of the ignition signals detected by the electronic control unit in FIG. 1 in the case that the erroneous connection exists in the wiring, and the ignition signal output in correspondence to the ignition signals; and

FIG. 5 is a layout view of a fuel injection control system of an engine in accordance with a prior art.

### DESCRIPTION OF PREFERRED EMBODIMENTS

A description will be given blow of a best mode for carrying out the present invention with reference to the accompanying drawings. In this case, the description is given of a case that the present invention is applied to a fuel injection system of a general purpose engine having two cylinders in the present embodiment. Further, for convenience of explanation in the drawings, a flywheel 45, and a cylinder 42 corresponding to a first cylinder and a cylinder 43 corresponding to a second cylinder are displayed so as to be arranged in parallel, however, they are arranged in series on the same crank shaft 4.

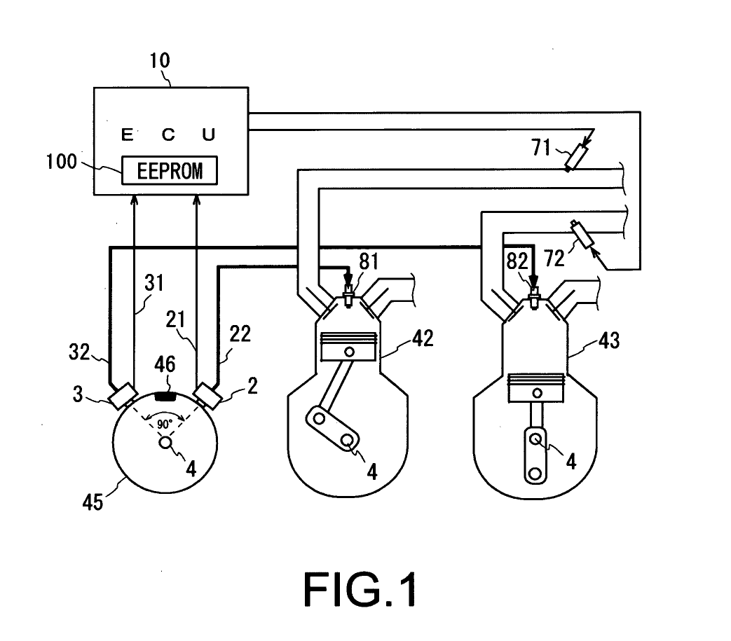

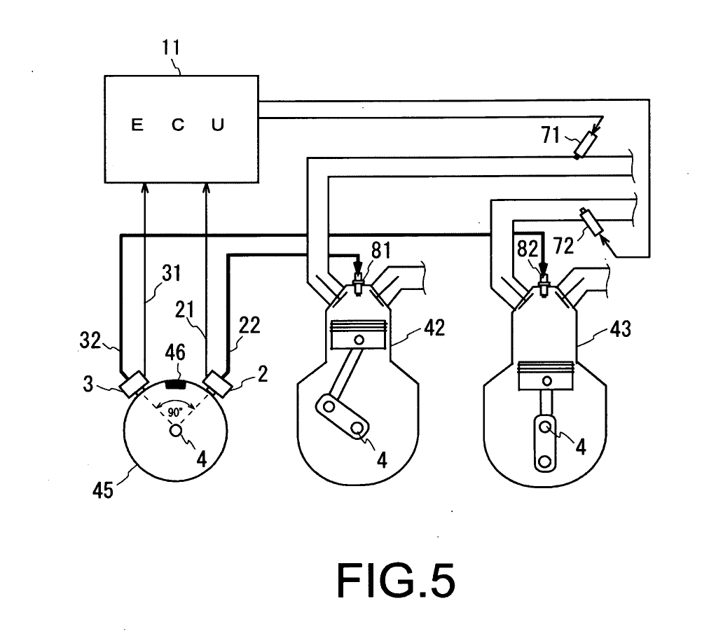

FIG. 1 shows a layout view of the present embodiment, a hardware structure of a fuel injection system of the engine in accordance with the present embodiment is approximately similar to the conventional system shown in FIG. 5, however, is different in a point that an electronic control unit 10 executes a fuel injection control method including an erroneous connection detecting method mentioned below, corrects a setting in such a manner as to output a fuel injection signal to the same cylinder at the same timing as the case of a correct connection at a time of detecting an erroneous connection of wirings, stores the corrected setting in a built-in non-volatile memory, and thereafter executes a fuel injection control on the basis of the corrected setting.

Further, an ignition device 2 for the cylinder 42 corresponding to the first cylinder arranged in the vicinity of a flywheel 45, and an ignition device 3 for the cylinder 43 corresponding to the second cylinder are respectively connected to injectors 81 and 82 by wirings 22 and 32, are respectively connected to different input terminals (not shown) in which connection portions are exposed onto an outer surface of the electronic control unit 10 by wirings 21 and 31, and are structured such as to input respective ignition signals.

Further, the ignition devices 2 and 3 detect a passage of a magnet 46 fixed to the flywheel 45 which is rotated by driving the engine, by a pickup coil, outputs an ignition signal from a secondary coil on the basis of an ignition timing corresponding to a crank angle position, and is structured such as to generate a spark in the injectors 81 and 82 via the wirings 22 and 32.

In other words, a power transistor is turned on by a voltage induced at a time when the magnet 46 fixed at a predetermined crank angle position of the flywheel 45 passes near the pickup coils of the ignition devices 2 and 3 and a current flows through the primary coil, the power transistor is turned off in a moment of passing through the magnet 46 and the current is shut off, and the ignition signal is output by generating a back electromotive force in the primary coil side.

The electronic control unit 10 is structured such as to detect a voltage signal in a primary side as a rotational signal of the engine, utilize this as a reference timing of a fuel injection timing, and output the fuel injection signal to the injectors 81 and 82 of the respective cylinders at a correct timing. In this case, the electronic control unit 10 is structured such that a program for executing each of procedures of the fuel injection control method including an erroneous connection detecting method of the wiring mentioned below is stored in a memory portion of a general fuel injection controlling electronic control unit for a general purpose engine utilizing the ignition signal as the reference timing of the fuel injection timing, and each of means mentioned below is achieved by the program and the memory portion.

The electronic control unit 10 is provided with an interval time storing means previously storing a combination of the interval times in the case that the wiring in the same engine stroke is in the correct connection and storing a combination of the measured interval times, an erroneous connection detecting means detecting the erroneous connection by comparing the combination of the interval times stored previously with the combination of the measured interval time, a setting changing means changing the setting in the case of detecting the erroneous connection, and a setting storing means storing the setting, as the means for executing the fuel injection control method including the erroneous connection detecting method mentioned below. Further, the electronic control unit 10 is provided with a timer function by a timer means, and is also provided with a non-volatile memory such as an EEPROM 100 or the like corresponding to the setting storing means for storing various settings in a non-volatile manner.

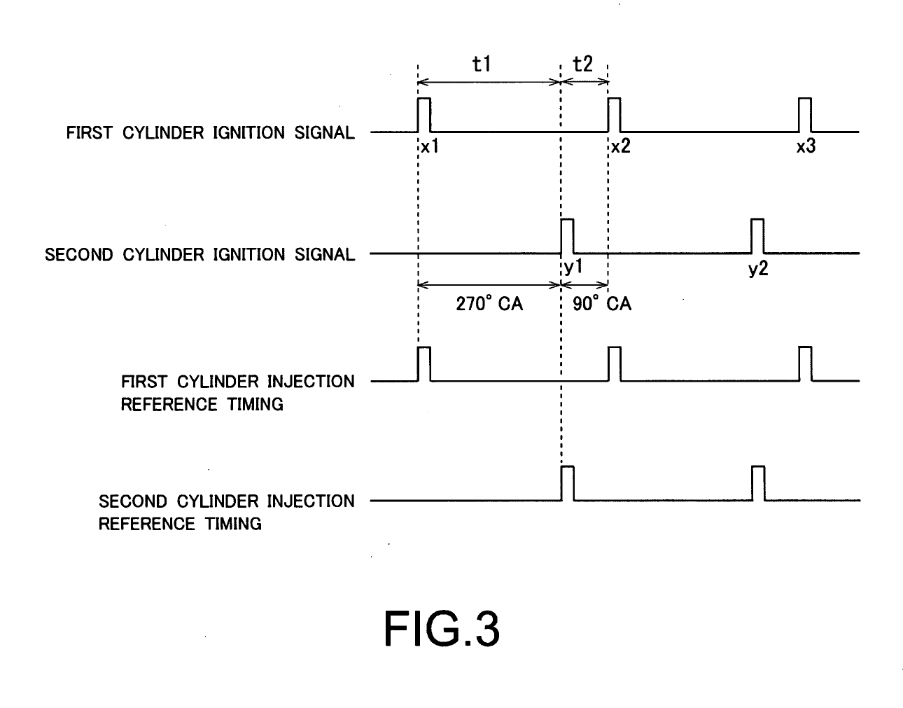

The ignition device 2 for the cylinder 42 and the ignition device 3 for the cylinder 43 are attached at an interval of a crank angle 90 degree as shown in FIG. 1, a crank angle interval from an ignition signal x1 for the cylinder 42 corresponding to the first cylinder to an ignition signal y1 for the cylinder 43 corresponding to the second cylinder is 270 degree as shown by a wave form chart in FIG. 3, and a crank angle interval from the ignition signal y1 to an ignition signal x2 for the next cylinder 42 is 90 degree. Further, the ignition timing of the injector 81 for the cylinder 42 and the ignition timing of the injector 82 for the cylinder 43 are respectively synchronized with an injection signal xn and an ignition signal yn.

In the case that the wirings 21 and 31 for inputting the ignition signal to the electronic control unit 10 have no erroneous connection and are in a correct connection, in the case that the engine is rotated approximately at a fixed state, a relation t1>t2 is obtained by comparing a time t1 from the ignition signal x1 to the ignition signal y1 with a time t2 from the ignition signal y1 to the ignition signal x2 as shown in the wave form chart in FIG. 3.

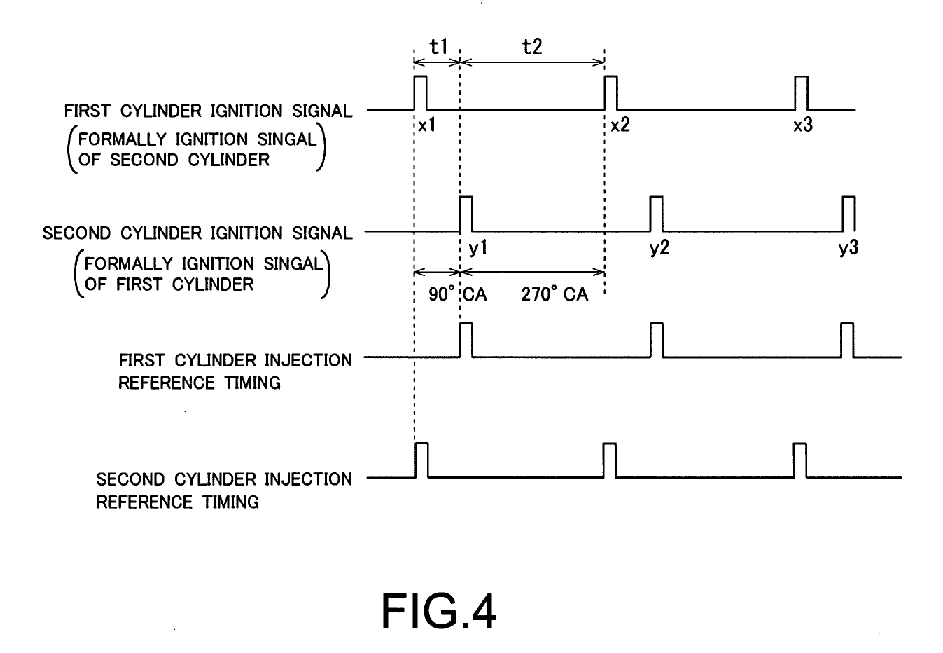

However, if the wirings 21 and 31 are inversely connected to the input terminal of the electronic control unit 10 on the basis of an erroneous connection, the relation t1<t2 is achieved as shown in a wave form chart in FIG. 4, the ignition timings of the injectors 81 and 82 are delayed at 270 degree, and there is generated a problem such as a reduction of an emission in the engine or the like.

Accordingly, the electronic control unit 10 measures the times t1 and t2 so as to compare the relation thereof with the relation in the case of the correct connection and detect the erroneous connection, at a time when the rotating speed fluctuation after starting the engine is small, as the erroneous connection detecting means, and corrects the setting in such a manner as to output the fuel ignition signal to the same cylinder at the same timing as the case of the correct connection, without actually replacing and correcting the connection so as to store in a non-volatile manner, in the case that the erroneous connection exists.

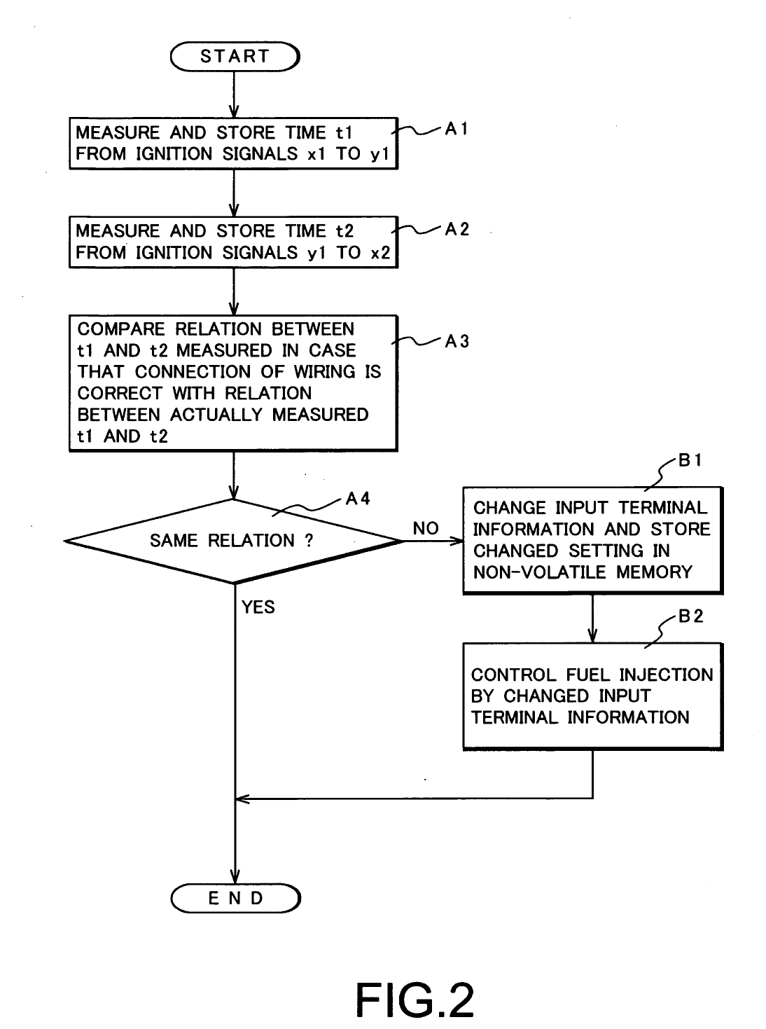

Next, a description will be given in detail of a motion of the electronic control unit 10 in accordance with the present embodiment, that is, a procedure of the fuel injection control method in accordance with the present invention including the erroneous connection detecting method, while using a flow chart in FIG. 2.

If the rotating speed is stabilized after starting the engine, the electronic control unit 10 measures the time t1 from the ignition signal x1 to the ignition signal y1 which are continuously input, by the interval time measuring means so as to store in the interval time storing means (A1), and measures the time t2 from the ignition signal y1 to the ignition signal x2 which are subsequently input in the same manner so as to store (A2).

Next, the step compares a correct magnitude relation between the times t1 and t2 which are measured in the case that the wiring previously stored in the interval time memory means is in the correct connection, with a magnitude relation between the times t1 and t2 which are measured in the same engine stroke by the erroneous connection detecting means (A3), and for example, determines whether or not the relation between the actually measured times t1 and t2 satisfies a relation t1>t2, in the case that the relation between the normal times t1 and t2 is stored as t1>t2 (A4).

Further, if they are identical, the step enters into the normal control without changing the setting so as to be finished, and in the case that the relation t1<t2 is inverted and is not identical, the step determines that the erroneous connection exists in the wiring, changes the signal set as the signal from the first cylinder from the setting changing means to the signal from the second cylinder and changes the signal set as the signal from the second cylinder to the signal from the first cylinder so as to store the input terminal information stored in the setting memory means in the non-volatile memory such as the EEPRPM 100 or the like in a non-volatile manner on the basis of this setting (B1), thereafter enters into the control outputting the fuel injection signal based on this setting (B2), and is finished.

Since the structure is made such that the electronic control unit 10 executes the fuel injection control mentioned above, it is possible to detect the erroneous connection of the wiring between the ignition devices 2 and 3 and the electronic control unit 10 in accordance with the comparatively simple processing procedure on the basis of the simple structure as mentioned above, and it is possible to output the fuel injection signal to the same cylinder at the same timing as the case based on the correct connection, without actually replacing and correcting the connection in the case of the erroneous connection.

Further, since any excessive process load is not applied to the CPU of the electronic control unit 10 by employing the comparatively simple processing procedure as mentioned above, and the cylinder discriminating means constituted by the crank angle detecting apparatus or the like is not necessary, it is possible to execute the fuel injection control method mentioned above without accompanying any excessive cost increase. In this case, the description is given of the case that the present invention is applied to the general purpose engine having two cylinders, however, the present invention is not limited to this, but can be similarly applied to any structure in which the adjacent interval times generated by the continuously output ignition signals are different in the engine having a plurality of cylinders.

Further, as the other method of detecting the erroneous connection from the continuously input ignition signals, for example, the method may store a ratio between the normal times t1 and t2 as a numerical value, compare a ratio between the times t1 and t2 on the basis of the actually input ignition signals, and determine whether or not they are an identical numerical value. Further, even in the case that three or more interval times of the different ignition signals exist in the engine having three or more cylinders, it is preferable to compare the combinations suitable for comparison in three or more interval times.

As mentioned above, in the fuel injection control apparatus of the engine having a plurality of cylinders and utilizing the ignition signal of the ignition device as the reference timing of the fuel injection timing, in accordance with the present invention, it is possible to detect the erroneous connection of the wiring between the ignition device and the fuel injection control apparatus without accompanying the cost increase, and execute the similar fuel injection control to the case of the correct connection, without actually correcting the connection.

1. A fuel injection control method executed by a fuel injection control apparatus which is provided in the engine having a plurality of cylinders in which ignition timings are different from each other per cylinder, and outputs a fuel ignition signal to an injector provided in each of the cylinders while using an ignition signal received from a plurality of ignition devices via wirings as a reference timing of the fuel injection timing, comprising the steps of:
detecting an erroneous connection of the wiring by comparing a combination of an interval time in ignition signals input by a plurality of wirings which are continuously measured, with a combination of the interval time in the case that the wiring is in a correct connection in the same engine stroke, which is previously stored, in accordance with a predetermined comparing method;
correcting a setting in such a manner as to output the fuel injection signal to the same cylinder at the same timing as the case that the wiring is in the correct connection, and storing the setting; and
thereafter outputting a fuel ignition signal on the basis of the corrected setting.

2. A fuel injection control method as claimed in claim 1, wherein in the case of detecting the erroneous connection of the wiring, the setting is corrected by changing the input terminal information for specifying the cylinder being relevant to the ignition signal which is previously stored per a plurality of input terminals of the fuel injection control apparatus to the input terminal information specifying the actually relevant cylinder and correcting the setting.

3. A fuel injection control method as claimed in claim 1, wherein the comparing method detects the erroneous connection of the wiring by comparing a first interval time from an input of an ignition signal for a measured predetermined cylinder to an input of the next ignition signal, a second interval time from the input of the measured next ignition signal to an input of further the next ignition signal, and a correct relation between the first interval time and the second interval time in the case that the previously stored wiring is in the correct connection, in accordance with a predetermined procedure.

4. A fuel injection control method as claimed in claim 2, wherein the comparing method detects the erroneous connection of the wiring by comparing a first interval time from an input of an ignition signal for a measured predetermined cylinder to an input of the next ignition signal, a second interval time from the input of the measured next ignition signal to an input of further the next ignition signal, and a correct relation between the first interval time and the second interval time in the case that the previously stored wiring is in the correct connection, in accordance with a predetermined procedure.

5. A fuel injection control method as claimed in claim 3, wherein the predetermined procedure compares a magnitude relation between the first interval time and the second interval time or a numerical value indicating a ratio between the first interval time and the second interval time, and determines the erroneous connection of the wiring in the case that both do not coincide.

6. A fuel injection control method as claimed in claim 4, wherein the predetermined procedure compares a magnitude relation between the first interval time and the second interval time or a numerical value indicating a ratio between the first interval time and the second interval time, and determines the erroneous connection of the wiring in the case that both do not coincide.

7. A fuel injection control apparatus of an engine having a plurality of cylinders comprising:
a plurality of input terminals for inputting an ignition signal by connecting each of wirings extended from ignition devices arranged in a plurality of cylinders;
an interval measuring means measuring an interval of the input ignition signals;
an interval time storing means storing a combination of the interval times in the case that the wiring is in a correct connection in the same engine stroke;
an erroneous connection detecting means detecting the erroneous connection by comparing a combination of stored interval times with a combination of the measured interval times;
a setting changing means changing a setting in the case of detecting the erroneous connection; and
a setting storing means storing the setting after being changed,
wherein the fuel injection control apparatus executes the fuel injection control method as claimed in claim 1.

8. A fuel injection control apparatus of an engine having a plurality of cylinders comprising:
a plurality of input terminals for inputting an ignition signal by connecting each of wirings extended from ignition devices arranged in a plurality of cylinders;
an interval measuring means measuring an interval of the input ignition signals;
an interval time storing means storing a combination of the interval times in the case that the wiring is in a correct connection in the same engine stroke;
an erroneous connection detecting means detecting the erroneous connection by comparing a combination of stored interval times with a combination of the measured interval times;
a setting changing means changing a setting in the case of detecting the erroneous connection; and
a setting storing means storing the setting after being changed,
wherein the fuel injection control apparatus executes the fuel injection control method as claimed in claim 2.

9. A fuel injection control apparatus of an engine having a plurality of cylinders comprising:
a plurality of input terminals for inputting an ignition signal by connecting each of wirings extended from ignition devices arranged in a plurality of cylinders;
an interval measuring means measuring an interval of the input ignition signals;
an interval time storing means storing a combination of the interval times in the case that the wiring is in a correct connection in the same engine stroke;
an erroneous connection detecting means detecting the erroneous connection by comparing a combination of stored interval times with a combination of the measured interval times;
a setting changing means changing a setting in the case of detecting the erroneous connection; and
a setting storing means storing the setting after being changed,
wherein the fuel injection control apparatus executes the fuel injection control method as claimed in claim 3.

10. A fuel injection control apparatus of an engine having a plurality of cylinders comprising:
a plurality of input terminals for inputting an ignition signal by connecting each of wirings extended from ignition devices arranged in a plurality of cylinders;
an interval measuring means measuring an interval of the input ignition signals;
an interval time storing means storing a combination of the interval times in the case that the wiring is in a correct connection in the same engine stroke;
an erroneous connection detecting means detecting the erroneous connection by comparing a combination of stored interval times with a combination of the measured interval times;
a setting changing means changing a setting in the case of detecting the erroneous connection; and
a setting storing means storing the setting after being changed,
wherein the fuel injection control apparatus executes the fuel injection control method as claimed in claim 4.

11. A fuel injection control apparatus of an engine having a plurality of cylinders comprising:
a plurality of input terminals for inputting an ignition signal by connecting each of wirings extended from ignition devices arranged in a plurality of cylinders;
an interval measuring means measuring an interval of the input ignition signals;
an interval time storing means storing a combination of the interval times in the case that the wiring is in a correct connection in the same engine stroke;
an erroneous connection detecting means detecting the erroneous connection by comparing a combination of stored interval times with a combination of the measured interval times;
a setting changing means changing a setting in the case of detecting the erroneous connection; and
a setting storing means storing the setting after being changed,
wherein the fuel injection control apparatus executes the fuel injection control method as claimed in claim 5.

12. A fuel injection control apparatus of an engine having a plurality of cylinders comprising:
a plurality of input terminals for inputting an ignition signal by connecting each of wirings extended from ignition devices arranged in a plurality of cylinders;
an interval measuring means measuring an interval of the input ignition signals;
an interval time storing means storing a combination of the interval times in the case that the wiring is in a correct connection in the same engine stroke;
an erroneous connection detecting means detecting the erroneous connection by comparing a combination of stored interval times with a combination of the measured interval times;
a setting changing means changing a setting in the case of detecting the erroneous connection; and
a setting storing means storing the setting after being changed,
wherein the fuel injection control apparatus executes the fuel injection control method as claimed in claim 6.
